(19) United States
(12) Patent Application Publication
(10) Pub. No.: US 2026/0202666 A1
(43) Pub. Date: Jul. 16, 2026

(54) SYSTEMS AND METHODS FOR WEARABLE EYE TRACKING SLIPPAGE DETECTION AND CORRECTION

(71) Applicant: XIAOCHUN NIE, Mountain View, CA (US)

(72) Inventor: XIAOCHUN NIE, Mountain View, CA (US)

(21) Appl. No.: 19/127,719

(22) PCT Filed: Nov. 14, 2023
(86) PCT No.: PCT/US2023/079667

§ 371 Date: May 6, 2025

Related U.S. Application Data
(60) Provisional application No. 63/383,814, filed on Nov. 15, 2022.

(51) Int. Cl. G02B 27/00; G02B 27/01; G06T 7/73; G06V 40/18

(52) U.S. Cl. CPC G02B 27/0093; G02B 27/0172; G06T 7/73; G06V 40/193; G02B 2027/0138

(57) ABSTRACT

Mapping between the gaze vector of a person's eye and a position of a feature of the eye in the field of view of an imaging sensor may be determined based on the position of the feature of the eye in an image of the eye captured using the imaging sensor and a position of a point the eye is gazing at on a display or a position of a point the eye is gazing in an image of the point. The imaging sensor and the display are stationary relative to the person's head. The point is stationary relative to the display. The mapping may be used to determine and correct slippage of the imaging sensor relative to the eye.

### BACKGROUND

Eye tracking can be used in a wide range of applications such as human machine interface, gaming, virtual reality, human behavior study and medicine etc.

### SUMMARY

Disclosed herein is a method comprising: perform the first eye tracking system calibration using first feature in the eye image taken by eye image sensor.

After the first calibration, a mapping from the first feature in the eye image to gaze vector can be generated.

After the first calibration, a mapping from gaze vector to first feature in the eye image can be generated.

After the first calibration, in an eye tracking session, using an eye image, a first feature can be obtained, using the first feature and the mapping from first feature in the eye image to gaze vector, a gaze vector can be obtained.

Perform the second eye tracking system calibration using the second feature in the eye image taken by the eye image sensor.

After the second calibration, a mapping from second feature in the eye image to gaze vector can be generated.

After the second calibration, in an eye tracking session, using an eye image, a second feature can be obtained, using the second feature and the mapping from second feature in the eye image to gaze vector, a gaze vector can be obtained.

After calibrations using the first feature and second feature, in an eye tracking session, the first feature can be used to generate a gaze vector, in the meantime, the second feature can be used to detect and correct slippage.

When the second feature is used for detecting and correcting slippage in an eye tracking session, first get a second feature from an eye image. Then use the mapping from the second feature in the eye image to gaze vector to generate a desired gaze vector.

Using the desired gaze vector and the mapping from gaze vector to first feature in the eye image, the desired first feature in the same eye image can be obtained.

In the same eye image, get the real first feature. Knowing both desired first feature and real first feature from the same image, the difference between them can be obtained. The difference can be used to detect the amount of slippage.

Slippage can be corrected by using this difference to offset the real first feature and obtain a corrected first feature in each subsequent eye image.

Using the corrected first feature and the mapping from first feature in the eye image to gaze vector, a corrected gaze vector can be generated from each subsequent eye image.

Some eye parameters are assumed to be available during eye tracking system calibration using the first or second feature.

### BRIEF DESCRIPTION OF FIGURES

FIG. 1 shows a 3D coordinate system.

FIG. 2 shows several 3D coordinate systems referred to herein.

FIG. 3A schematically shows a system with a head mounted display.

FIG. 3B schematically shows a system with a head mounted field camera.

FIG. 4 shows an offset between the eye's optical axis and visual axis.

FIG. 5 schematically shows an image of a pupil.

FIG. 6 show a data flow.

### DETAILED DESCRIPTION

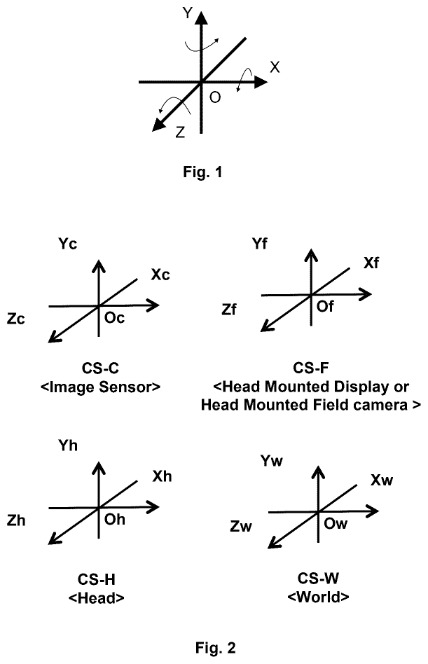

A gaze vector is a 3D vector pointing from the center of the user's eye to the point where the user is looking at. It can be represented in one of the coordinate systems shown in FIG. 2, such as the field coordinate system CS-F. A gaze point is a physical point in the world or an image of a point on a display which the user is looking at.

In an embodiment, the user wears an eye image sensor in front of the eye. The eye image sensor is for detecting eye position by taking images of the eye from the outside. The position and orientation of the eye image sensor relative to user's head don't change during calibrations.

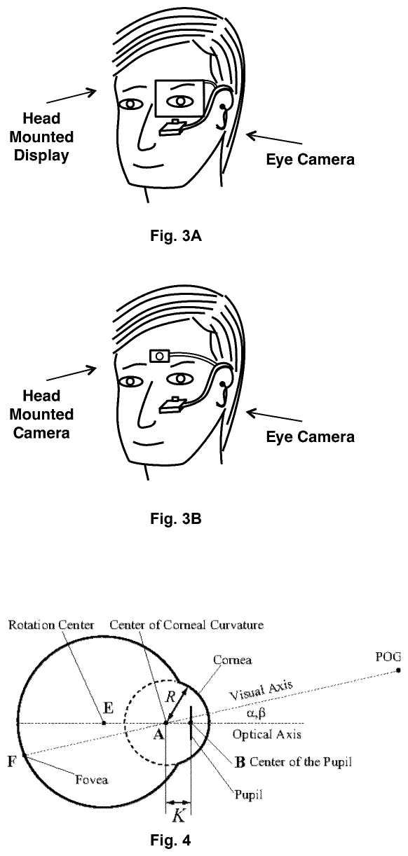

The system can also include a head-mounted display, as shown in FIG. 3A, or a head-mounted field camera, as shown in FIG. 3B. The head mounted display can show images in front of the user's eye so the eye can see those images. The head mounted field camera can take images of the area in front of the user. The head mounted display or the head mounted field camera has fixed relative position and orientation to the eye image sensor.

Slippage is when the relative position and/or orientation between the eye image sensor and the eye changes due to weight, motions or other reasons, usually in a small amount.

A calibration is to create a mapping between feature(s) of the eye in an eye image and gaze vector using calibration points in front of user's eye. As an example, if the pupil position is used as a feature, a gaze vector can be obtained from the pupil position and the mapping. In this case, the calibration is to find a relationship between the position of the feature in the eye image and the gaze vector.

Before calibration, it is assumed some eye parameters are already known. These eye parameters can be used along with eye feature(s) from the eye image to create calibration results. These eye parameters can include the position of the eyeball center in one of the coordinate systems shown in FIG. 2, such the eye image sensor coordinate system CS-C, or an offset between the eye's optical axis and visual axis, as shown in FIG. 4, or other information. During calibration, in one embodiment, a calibration point is a point displayed on a head mounted display as shown in FIG. 3A. The calibration point is stationary relative to the user's eye, and a calibration point image position can be obtained. In another embodiment, a physical point in front of user is used as a calibration point. The physical point can be recorded from a head mounted field camera, as shown in FIG. 3B, and a calibration point image position can be obtained. In both embodiments, a calibration point is used once at one time during calibration. Multiple calibration points can be used at different points in time. When the user is looking at the calibration point, the calibration point is a gaze point.

During calibrations, gaze vector GazeVector can be obtained from calibration point using different sensors and methods. In one embodiment, it is assumed the calibration point is either displayed on the head mounted display or its image is captured by head mounted field camera. The position of the image of the calibration point is known in the image plane of the head mounted display or the head mounted field camera. We can refer to this position as CaliPosition. A confirmed gaze vector GazeVector can be obtained from the position of the image of the calibration point as:
GazeVector=CaliPosition_to_GazeVector(CaliPosition), see Method C1 for details.

During calibration using the first feature, when the user is looking at the calibration point, a calibration point image position can be obtained, a first feature is obtained in the eye image taken by the eye image sensor. By repeating this step multiple times, multiple pairs of the calibration point image position and the first feature are obtained. Using these data and the eye parameters, a mapping MAP_Feature1_to_GazeVector( ) from first feature in the eye image to gaze vector can be generated, see Method C4, C5 for details. And using the same data, a mapping MAP_GazeVector_to_Feature1( ) from gaze vector to first feature in the eye image can be generated, see Method C4, C5 for details.

After the first calibration, in an eye tracking session, a first feature Feature1 can be obtained from the eye image, see Method C2 for details; using the first feature, a gaze vector can be obtained using: GazeVector1=MAP_Feature1_to_GazeVector(Feature1).

During calibration using a second feature, when the user is looking at a calibration point, a second feature is obtained in the eye image taken by the eye image sensor. Repeat this step multiple times, multiple pairs of calibration point image position and second feature are obtained. Using these data and the eye parameters, a mapping MAP_Feature2_to_GazeVector( ) from second feature in the eye image to gaze vector can be generated.

After the second calibration, in an eye tracking session, a second feature Feature2 can be obtained from an eye image, using the second feature, a gaze vector can be obtained using: GazeVector2=MAP_Feature2_to_GazeVector(Feature2).

When the second feature is used for detecting and/or correcting slippage in an eye tracking session, first get the second feature Feature2 from an eye image. Then use the mapping from second feature in the eye image to gaze vector to generate a desired gaze vector: GazeVector2_d=MAP_Feature2_to_GazeVector(Feature2)

Using the desired gaze vector GazeVector2_d and the mapping from gaze vector to first feature in the eye image, a desired first feature in the eye image can be obtained as:

$$Feature1\_d = MAP\_GazeVector \_to \_Feature1 ( GazeVector2\_d )$$

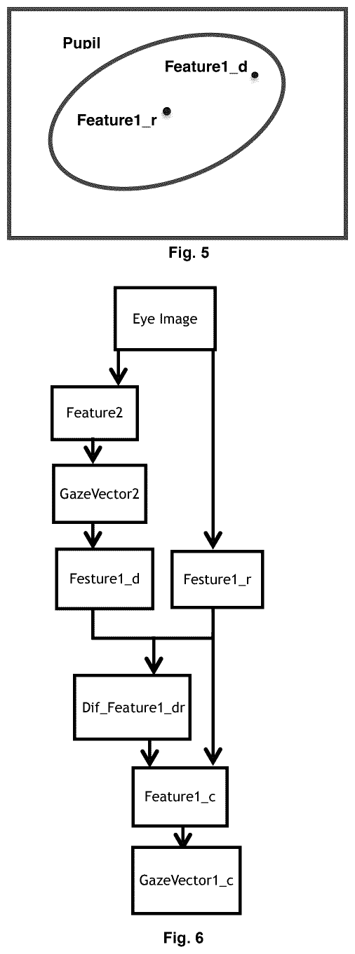

At the same time using the same eye image, get the real first feature Feature1_r. Knowing both desired first feature and real first feature from the same image, the difference between them Dif_Feature1_dr can be obtained as: Dif_Feature1_dr=DIF_Feature1(Feature1_d, Feature1_r). In an embodiment, as shown in FIG. 5, pupil center position in eye image is used as first feature, if there is slippage happening, the desired first feature will be the desired pupil center position, and the real first feature will be the real pupil canter position, these 2 positions in the eye image are likely to be different due to the slippage.

The amount of difference Dif_Feature1_dr can be used to detect the amount of slippage as: Slippage=Dif_Feature_to_Slippage(Dif_Feature1_dr), see Method C14 for details.

To correct slippage, in an eye tracking session, using this difference Dif_Feature1_dr to offset the real first feature Feature1_s, a corrected first Feature1_c is obtained as: Feature1_c=OFFSET_Feature1(Feature1_s, Dif_Feature1_dr), see Method C16 for details.

Using the corrected first feature Feature1_c and the mapping from first feature in the eye image to gaze vector, a corrected gaze vector GazeVector1_c can be generated as:

$$GazeVector1\_c = MAP\_Feature1 \_to \_GazeVector ( Feature1\_c ) .$$

For slippage correction, the same Dif_Feature1_dr can be used on each subsequent eye image to generate GazeVector1_c.

The first and second calibration can be done at the same time using the same set of calibration points. The first and second calibration can be done at different times or using different sets of calibration points, or both.

The first feature can be a feature that is more accurate and/or faster to process. Certain image features are more robust to noise, for example, an average value of pixel positions, and generate more stable and accurate results. In an embodiment, the position of the pupil center in the eye image can be used as the first feature. An example can be found in Reference 2.

The second feature can be a feature that is not sensitive to slippage and/or takes more time to process. In an embodiment, the contour and position of the pupil center, or shape of iris, limbus etc. in the eye image can be used as the second feature. An example can be found in Reference 3.

Mathematical utility functions used in this disclosure are listed in Part A2 of the Appendix section.

The position, orientation and pose of a 3D object in the 3D coordinate system is defined in A1.7. Head pose includes head position and head orientation.

A 3D coordinate system using the right-hand rule is defined in Part A1.1 of the Appendix section. This disclosure refers to the following coordinate system as shown in FIG. 2. They are defined as:
Eye image sensor coordinate system Xc-Yc-Zc-Oc: CS-C is defined in A1.2.
Field coordinate system Xf-Yf-Zf-Of: CS-F is defined in A1.3
Head coordinate system Xh-Yh-Zh-Oh: CS-H is defined in A1.4
World coordinate system Xw-Yw-Zw-Ow: CS-W

### System Hardware, Software and Configuration

An imaging sensor measures at least the brightness of light. An imaging sensor may additionally measure the color of light. A camera is a kind of imaging sensor. Other kinds of imaging sensors can be used here in similar ways. A camera can be of color, grayscale, infrared or non-infrared, etc. Parameters of a camera include its physical dimensions, resolution and focal length of the lens mounted etc. The imaging sensor referred to in this disclosure can be a color, or grayscale camera, it can also be single camera, an array of cameras, or a combination of different image sensing devices.

Head Gear. The apparatus to fix the eye image sensors, head mounted display, field camera, and other sensors and/or devices to the user's head. It can be a glasses frame, a head band or a helmet, etc., depending on the applications.

Computer. A computer processes the output of the sensing unit and calculates the motion/gesture tracking results. It can be either an embedded system or a desktop system.

Software. The computer software implements the algorithms and enables the workflows.

Configuration for one embodiment, as shown in FIG. 3A, as an eye tracking system, eye image sensor and a head mounted display are mounted on a rigid platform and are attached to a harness frame worn by the user. The eye image sensor is pointing to an eye of the user. The position and orientation of the eye image sensor relative to the head mounted display do not change.

Configuration for another embodiment, as shown in FIG. 3B, as an eye tracking system, an eye image sensor and a head mounted field camera are mounted on a rigid platform and are attached to a head harness worn by the user. The eye image sensor is pointing to an eye of the user. The position and orientation of the eye image sensor relative to the head mounted field camera do not change.

### Method

C1. During calibration using the first feature, for each calibration point, a gaze vector can be obtained. In one embodiment, assuming calibration point image position CaliPosition is a 2D vector in the image plane, and GazeVector is a 3D vector in CS-F, we have:

$$GazeVector = CaliPosition\_to \_GazeVector ( CaliPosition ) = v\_from \_p ( CaliPosition )$$

C2. During calibration using the first feature, when the user is looking at a calibration point, a gaze vector GazeVector is obtained. The first feature Feature1 is obtained in the eye image taken by the eye image sensor. In one embodiment, assuming the position of the pupil center in the eye image is used as the first feature, the first feature can therefore be represented as 2D vector.

C3. In each above step, a pair of gaze vector and first feature is obtained. Repeat the above step multiple times, multiple pairs of gaze vector and first feature {GazeVector_i, Feature1_i), i=1 . . . n are obtained.

C4. Using these data and the eye parameters, a mapping GazeVector=MAP_Feature1_to_GazeVector(Feature1) from first feature in the eye image to gaze vector can be generated. And using the same data, a mapping Feature1=MAP_GazeVector_to_Feature1(GazeVector) from gaze vector to first feature in the eye image can be generated. The mapping is to convert variables from one space to another space. Depending on the precision needed, one or more samples are needed.

C5. The method to generate MAP_Feature1_to_GazeVector( ) and MAP_GazeVector_to_Feature1( ) can be one of many existing eye tracking calibration methods, such as model-based algorithms, interpolation, or machine learning etc. An example can be found in Reference 1.

C6. During calibration using the second feature, when the user is looking at the calibration point, a gaze vector GazeVector is obtained. At the same time, the second feature Feature2 is obtained in the eye image taken by the eye image sensor.

C7. Repeat the above step multiple times, multiple pairs of gaze vector and second feature {GazeVector_i, Feature2_i), i=1 . . . n are obtained.

C8. Using these data and the eye parameters, a mapping GazeVector=MAP_Feature2_to_GazeVector(Feature2) from second feature in the eye image to gaze vector can be generated.

C9. The method to generate MAP_Feature2_to_GazeVector( ) can be one of many existing eye tracking calibration methods, which include model-base algorithms, interpolation, or machine learning etc.

C10. When the second feature is used for detecting and/or correcting slippage in an eye tracking session, a desired gaze vector is obtained from a second feature in an eye image as: GazeVector2_d=MAP_Feature2_to_GazeVector(Feature2)

C11. And a desired first feature in this image can be obtained as:

$$Feature1\_d = MAP\_GazeVector \_to \_Feature1 ( GazeVector2\_d )$$

C12. Using the same eye image, get the real first feature Feature1_r. Knowing both desired first feature and real first feature from the same image, the difference between Feature1_d and Feature1_d can be obtained as:

$$Dif\_Feature1 \_dr = DIF\_Feature1 ( Feature1\_d , Feature1\_r ) .$$

C13. In one embodiment, assuming the position of the pupil center in the eye image is used as the first feature, the first feature can therefore be represented as 2D vector, where Feature1_d=(x1_d,y1_d), Feature1_r=(x1_r,y1_r). The difference between Feature1_d, Feature1_r can be defined as: Dif_Feature1_dr=DIF_Feature1(Feature1_d,Feature1_r)=p_sub(Feature1_d,Feature1_r), See A2.2.2.

C14. Dif_Feature1_dr can be used to detect the amount of slippage as: Slippage=Dif_Feature_to_Slippage(Dif_Feature1_dr). In one embodiment, Dif_Feature1_dr is a 2D vector, and its length is used to measure the amount of slippage: Slippage=Dif_Feature_to_Slippage(Dif_Feature1_dr)=p_len(Dif_Feature1_dr)*k, where k can be a scale factor.

C15. When Slippage is over a certain threshold, slippage is detected. In one embodiment, the threshold can be determined by the minimum error the system can accept caused by slippage.

C16. Dif_Feature1_dr can be used to correct slippage. First offsetting the real first feature Feature1_s in each subsequent eye image with Dif_Feature1_dr, a corrected first Feature1_c is obtained as: Feature1_c=OFFSET_Feature1(Feature1_s, Dif_Feature1_dr). In one embodiment, Feature1_c, Feature1_s and Dif_Feature1_dr are 2D vectors, therefore we have:

$$Feature1\_c = OFFSET\_Feature1 ( Feature1\_s , Dif\_Feature1 \_dr ) = p\_add ( Feature1\_s , Dif\_Feature1 \_dr ) , See A 2.2 \text{.3} .$$

C17. Using the corrected first feature Feature1_c and the mapping from first feature in the eye image to gaze vector, a corrected gaze vector GazeVector1_c can be generated as:

$$GazeVector1\_c = MAP\_Feature1 \_to \_GazeVector ( Feature1\_c ) .$$

C18. FIG. 6 show the data flow from eye image to GazeVector1_c when the second feature is used for slippage detection and correction, and first feature is used to generate the gaze vector.

### APPENDIX

The mathematical tools listed in the Appendix are used in the Methods section.

### A1. Coordinate Systems

A1.1. A 3D coordinate system has three axes, X, Y and Z, as shown in FIG. 1. Right hand rule is applied for the order of the axes and the positive rotation directions.

A1.2. Having the eye image sensor sensing direction facing forward, the eye image sensor coordinate system CS-C has x axis pointing to the right, y axis pointing to the top and z axis is pointing to the opposite direction of the lens. Its origin is at the optic center of the camera.

A1.3. The filed coordinate system CS-F is defined for both head mounted display and head mounted field camera. It has x axis pointing to the right of its image plane, y axis pointing to the top of its image plane. For head mounted display, its z axis is pointing to the user's eye and its origin is at the center of the eyeball. For head mounted field camera, its z axis is pointing in the opposite direction of the lens and its origin is at the optic center of the field camera.

A1.4. Having the head facing forward, the head coordinate system has x axis pointing to the right, y axis pointing to the top and z axis pointing to the opposite direction of the nose.

A1.5. A point in 2D Coordinates can be represented by a 2D vector p=(x, y). The vector is from the origin of the coordinate system to the position of the point.

A1.6. A point in 3D Coordinates can be represented by a 3D vector v=(x, y, z). The vector is from the origin of the coordinate system to the position of the point.

A1.7. The position of a 3D object in a 3D coordinate system is described as (x,y,z). Orientation of a 3D object in a 3D coordinate system can be described with quaternion, 3×3 matrix, Euler angles etc. The pose of a 3D object in a 3D coordination system is described as its position and its orientation.

A1.8. An image plane is defined as a 2D coordinate system with the origin in its center. A point in the image plane is a 2D vector. An image place can exist in CS-F, where their x, and y axes are aligned. In one embodiment, the position of the center of the image plane is at the position (0, 0,−FOC_LEN) in CS-F, where FOC_LEN is referred as focal length.

A2. 2D vector, 3D Vector

A2.2.1 A 2D vector has two elements

$$p = ( x , y )$$

A2.2.2 Subtract two 2D vector pa=(xa,ya), pb=(xb,yb):

$$p\_sub ( x 1 , xb ) = ( x a - xb , ya - y b )$$

A2.2.3 Add two 2D vector pa=(xa,ya), pb=(xb,yb):

$$p\_add ( x 1 , xb ) = ( x a + xb , ya + y b )$$

A2.2.4 The length of a 2D vector p=(x,y):

$$p\_len ( p ) = sqrt ( x * x + y * y )$$

A2.2.5 A 3D vector has three elements

$$v = ( x , y , z )$$

A2.2.6 The length of a 3D vector v=(x,y,z):

$$v\_len ( v ) = sqrt ( x * x + y * y + z * z )$$

2.2.7 Conver 3D vector v to 2D vector p=(x,y):

$$v\_from \_p ( p ) = ( x , y , FOCAL\_LEN )$$

where FOCAL_LEN is the distance from the center of the 2D plane to the origin of the 3D coordinate system

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCES

The disclosure of each of the references in this section is hereby incorporated by reference in its entirety.
Reference 1: U.S. patent application Ser. No. 16/753,907.
Reference 2: U.S. patent application Ser. No. 15/387,024.
Reference 3: Wang, Rui, et al. “Eye gaze tracking based on the shape of pupil image.” 2017 International Conference on Optical Instruments and Technology: Optoelectronic Imaging/Spectroscopy and Signal Processing Technology. Vol. 10620. SPIE, 2018.

1. A method comprising:
while a person's eye is gazing at a first point in a 3D space the person is in, capturing a first image of the eye using a first imaging sensor and capturing a first reference image of the first point using a second imaging sensor, wherein the first imaging sensor and the second imaging sensor are stationary relative to the person's head;
determining first mapping between a gaze vector of the eye and a position of a first feature of the eye in a field of view of the first imaging sensor, based on the position of the first feature of the eye in the first image and a position of the first point in the first reference image;
while the eye is gazing at a second point in the 3D space, capturing a second image of the eye using the first imaging sensor and capturing a second reference image of the second point using the second imaging sensor;
determining second mapping between the gaze vector and a position of a second feature of the eye in the field of view of the first imaging sensor, based on the position of the second feature of the eye in the second image and a position of the second point in the second reference image.

2. A method comprising:
while a person's eye is gazing at a first point on a display, capturing a first image of the eye using a first imaging sensor, wherein the first imaging sensor is stationary relative to the person's head, the display is stationary relative to the person's head, and the first point is stationary relative to the display;
determining first mapping between a gaze vector of the eye and a position of a first feature of the eye in a field of view of the first imaging sensor, based on the position of the first feature of the eye in the first image and a position of the first point on the display;
while the eye is gazing at a second point on the display, capturing a second image of the eye using the first imaging sensor, wherein the second point is stationary relative to the display;
determining second mapping between the gaze vector of the eye and a position of a second feature of the eye in the field of view of the first imaging sensor, based on the position of the second feature of the eye in the second image and a position of the second point on the display.

3. The method of claim 1, wherein the first feature is a center of the pupil of the eye and the second feature is the iris or the limbus of the eye.

4. The method of claim 1, wherein determining the first mapping or determining the second mapping is further based on geometric characteristics of the eye.

5. The method of claim 4, wherein the geometric characteristics comprise a position of a center of the eyeball of the eye, an offset between an optical axis of the eye and a visual axis of the eye, or both.

6. A computer program product comprising a non-transitory computer readable medium having instructions recorded thereon, the instructions when executed by a computer implementing the method of claim 1.

7. A method comprising:
obtaining first mapping between a gaze vector of a person's eye and a position of a first feature of the eye in a field of view of a first imaging sensor, wherein the first imaging sensor is stationary relative to the person's head;
obtaining second mapping between the gaze vector and a position of a second feature of the eye in the field of view of the first imaging sensor;
determining the gaze vector based on the second mapping and the position of the second feature of the eye in the field of view of the first imaging sensor;
determining a predicted position of the first feature of the eye in the field of view of the first imaging sensor based on the gaze vector and the first mapping;
obtaining a real position of the first feature of the eye in the field of view of the first imaging sensor;
determining slippage of the first imaging sensor relative the person's head based on the predicted position and the real position.

8. The method of claim 7, wherein the first feature is a center of the pupil of the eye and the second feature is the iris or the limbus of the eye.

9. The method of claim 7, further comprising determining a corrected position of the first feature of the eye in the field of view of the first imaging sensor, based on the predicted position and the real position.

10. The method of claim 8, further comprising determining a corrected gaze vector of the eye based on the corrected position and the first mapping.

11. A computer program product comprising a non-transitory computer readable medium having instructions recorded thereon, the instructions when executed by a computer implementing the method of claim 7.

12. The method of claim 2, wherein the first feature is a center of the pupil of the eye and the second feature is the iris or the limbus of the eye.

13. The method of claim 2, wherein determining the first mapping or determining the second mapping is further based on geometric characteristics of the eye.

14. The method of claim 13, wherein the geometric characteristics comprise a position of a center of the eyeball of the eye, an offset between an optical axis of the eye and a visual axis of the eye, or both.

15. A computer program product comprising a non-transitory computer readable medium having instructions recorded thereon, the instructions when executed by a computer implementing the method of claim 2.
